(19) United States
(12) Patent Application Publication
(10) Pub. No.: US 2026/0077746 A1
(43) Pub. Date: Mar. 19, 2026

(54) BRAKE ASSEMBLY, STEERING ARM ASSEMBLY AND RACING WHEELCHAIR

(71) Applicant: RGK Wheelchairs Ltd., Burntwood (GB)

(72) Inventor: Phillip Stone, Burntwood (GB)

(73) Assignee: RGK Wheelchairs Ltd., Burntwood (GB)

(21) Appl. No.: 19/317,749

(22) Filed: Sep. 3, 2025

(30) Foreign Application Priority Data
Sep. 16, 2024 (DE) 102024126613.9

(51) Int. Cl. B60T 7/10; A61G 5/10; B60T 11/04; G05G 1/01; G05G 5/04; G05G 5/05

(52) U.S. Cl. CPC B60T 7/102; A61G 5/1035; A61G 5/1051; B60T 11/046; G05G 1/01; G05G 5/04; G05G 5/05; G05G 2505/00

(57) ABSTRACT

A brake assembly for a personal mobility vehicle, in form of a racing wheelchair, comprises a brake lever for actuating a brake cable, wherein the brake lever is a 3D printed glass filled nylon unit, in particular with up to 30% glass filled nylon. A steering arm assembly comprises a steering arm with the brake assembly integrated into the steering arm A racing wheelchair with one front wheel is attached to a wheelchair frame via a fork, with two drive wheels as well as a steering cage mounted on the rear of the wheelchair frame. The brake assembly and/or the steering arm assembly are mounted to the wheelchair frame.

### CROSS-REFERENCE TO RELATED APPLICATIONS

This application claims priority from German Patent Application No. DE102024126613.9, filed Sep. 16, 2024, the disclosure of which is incorporated herein by reference in its entirety.

### BACKGROUND OF THE INVENTION

This invention relates in general to a brake assembly for a personal mobility vehicle, in particular in form of a racing wheelchair, comprising a brake lever for actuating a brake cable. It also relates to a steering arm assembly comprising a steering arm of the personal mobility vehicle with such a brake assembly. Further, the present disclosure relates to a racing wheelchair with one front wheel attached to a wheelchair frame via a fork, with two drive wheels as well as a steering cage mounted on the rear of the wheelchair frame and with such a brake assembly and/or such a steering arm assembly.

The traditional design of a racing wheelchair steering involves using an off-the shelf bike brake lever. This requires a steering tube to be cylindrical and of a set diameter and thickness. The brake levers typically used are larger and heavier than required for racing wheelchairs as they are developed specifically for bikes.

To integrate a steering arm into a frame of a racing wheelchair is known. FIG. 1 shows the front of a respective racing wheelchair 1 of TOYOTA GAZOO Racing Europe GmbH. Said racing wheelchair 1 has a fork 2 for mounting a front wheel 3; and the fork 3 is connected with a frame 4 carrying also not shown drive wheels and a steering cage for a user. A steering arm 5 is inserted into the frame 4 and is equipped with two wing like steering means 6a, 6b. Further a compensator assembly 7 is attached to the frame 4 and the fork 2.

It is the object of the invention to further develop the known brake assembly to overcome the drawbacks of the prior art. In particular weight is to be reduced.

### SUMMARY OF THE INVENTION

This invention relates in general to a brake assembly for a personal mobility vehicle, in particular in form of a racing wheelchair, comprising a brake lever for actuating a brake cable. It also relates to a steering arm assembly comprising a steering arm of the personal mobility vehicle with such a brake assembly. Further, the present disclosure relates to a racing wheelchair with one front wheel attached to a wheelchair frame via a fork, with two drive wheels as well as a steering cage mounted on the rear of the wheelchair frame and with such a brake assembly and/or such a steering arm assembly.

This object is achieved in that the brake lever is a three dimensional (3D) printed glass filled nylon unit, with up to 30% glass filled nylon.

According to an embodiment of the present disclosure the brake lever is adapted to be mounted to a steering arm in form of 3D printed aluminium, in particular Aluminium grade ALSI10 mg and/or with a triangular cross-section with smoothed edges.

A further embodiment is characterized in that the brake lever is adapted to be pivotally mounted between the two mounting plates provided by the steering arm via a lever pivot extending from one mounting plate to the other mounting plate and passing through the brake lever.

A still further embodiment is characterized by a spring device, in particular comprising a spring, preferably in form of a coil spring, which is attached at a spring mount pin and engages the brake lever and/or the brake cable.

Further, it is proposed that the spring mount pin is adapted to be mounted between the two mounting plates, extending from one mounting plate to the other mounting plate in front of the brake lever, wherein the spring preferably extends into the brake lever via a brake lever opening.

It is also proposed to use at least one stop element limiting the movement of the brake lever, wherein preferably each mounting plate provides one stop element between the spring mount pin and the brake lever.

Embodiments can be further characterized in that the brake cable extends from the brake lever longitudinally through the steering arm.

The present disclosure also provide a steering arm assembly comprising a steering arm with a brake assembly according to the present disclosure being integrated into the steering arm.

According to an embodiment the steering arm is formed with the mounting plates and steering means, preferably in form of wings and/or in travelling direction of the personal mobility vehicle in front of the mounting plates.

Another embodiment is characterized in that each wing has a smaller surface area in the travelling direction compared to the side area adapted for being gripped from the side by a user of the personal mobility vehicle.

A further embodiment is characterized by a frame formed with the steering arm for enforcement, providing a ribbing and/or extending longitudinally and across the interior of the steering arm.

It is also proposed that the frame, in particular in the region of the ribbing, provides one or more brake throughs or openings for the brake cable.

Still further, an embodiment of the present disclosure is characterized by a brake cable through hole at the front end of the steering arm in the travelling direction allowing the brake cable to exit from the interior of the steering arm.

Another embodiment is characterized by at least one further opening of the steering arm, in particular at the side opposite the mounting plates, for surveying the threading of the brake cable through the steering arm.

It is also proposed that the steering arm is adapted to be integrated into a personal mobility vehicle frame, in particular with at least one first fastening element, and attached to a fork for a front wheel of the personal mobility vehicle, in particular with at least one second fastening element.

Still further, it is proposed that the first fastening element comprises a bolt, in particular a lightweight titanium bolt, extending through another opening of the steering arm at the side of the mounting plates and at the front end in the travelling direction of the personal mobility vehicle, and/or the second fastening element comprises a clamp adapted to be fastened to a stem of the fork, in particular via a mounting pin.

Another embodiment of the present disclosure is characterized in that the personal mobility vehicle frame is provided as a carbon frame and/or with at least a region having a non-circular cross-section and/or with at least one wall section thick end.

The present disclosure also provides a racing wheelchair with a front wheel attached to a wheelchair frame via a fork and with two drive wheels as well as a steering cage mounted on the rear of the wheelchair frame.

The racing wheelchair is further characterized by a brake assembly according to the present disclosure and/or a steering arm assembly according to the present disclosure.

It is also proposed that the wheelchair frame has a recess for accommodating the steering arm such that the top surface of the steering arm flushes into the wheelchair frame, and/or the wheelchair frame tapers at its front and flushes into the fork, preferably with a cylindrical region.

Still further it is proposed that a stem of the fork is machined and/or has a larger diameter at its base to house a bearing, in particular a sealed angular contact bearing, between the fork and the wheelchair frame, and/or extends through the wheelchair frame and passes a further bearing, in particular a crown race bearing, to enter the steering arm.

Embodiments of the present disclosure are characterized by a compensator assembly, in particular comprising a rocking bar, attached to the fork and the wheelchair frame that allows the wheelchair user to preset a turning circle for the wheelchair.

Thus, the present disclosure provides a brake assembly for a personal mobility vehicle with a brake lever mechanism that is light weight and small in profile. A steering arm may be made using 3D printed aluminum that can be designed into an aerodynamic form for better performance while allowing for the brake assembly to be integrated into the steering arm. Aluminum grade ALSI10 mg may be used for the steering arm and the cross-section of the steering arm can depart from a cylindrical form. ALSI10 mg is a lightweight, high strength aluminum alloy that is widely used in the aerospace and automotive industries.

The steering arm is a handlebar, and the handlebar may have a hollow structure, which is reinforced with an internal ribbing that runs longitudinally and across the part. Ribs may have holes such that the brake cable can be threaded through the holes to guide it. This type of reinforcement within a hollow structure is generally only possible when 3D printed in metal using direct metal laser sintering (DMLS). This method also allows local areas to have the wall section thickened to better support areas subject to more force, such as the steering means on the handlebar.

The brake lever is 3D printed from a glass filled nylon, with 30% glass filled nylon being favorable. This material of the brake lever makes it durable enough for use but has a weight of around 5 g versus 85 g for a lightweight standard bike lever. This is a 94% weight reduction.

It is common in existing racing wheelchair designs to have the handlebar mounted from a fork stem running over the top of a wheelchair frame. Thus, the known handlebar will protrude from the main body of the frame and create additional drag acting on the wheelchair. In contrast, according to the present disclosure, the handlebar is adapted as an inset of the wheelchair frame, which may have a carbon frame profile, for removing drag

The handlebar steering means, which remind one of wings, may be positioned in front of the brake lever position, in forward travelling direction, to allow a user to have unobstructed access. The brake assembly may have a mechanical component, that is integrated into the handlebar to prevent the brake lever being pressed into a wing or past a return spring limit. This component may be in form of two stop elements provided on two mounting plates for the brake lever.

The steering section of the handlebar is comprised of two wings that have a minimal surface area in the travelling direction, when compared with novel racing handlebars the reduction in surface area is 77%. Each wing may be designed to not only to have a minimum surface area in the travelling direction, but also a wider area on the sides for the user to grip from the side. A wider wing makes it easier for the user to steer the racing wheelchair and react quickly to cornering. The position of the brake lever of around 10 to 30 mm behind the wings allows the user to twist their wrist from a steering position to access the brake lever quickly.

The position of the wings may be changed on the handlebar to be between 40 to 200 mm from the front end of the handlebar. This is achievable in manufacture as the part is 3D printed and does not require any tooling to be made.

The present disclosure also provides a wheelchair, which is a hybrid manual racing wheelchair that is composed of an aluminum seating cage and a carbon fiber axle and main frame. The wheelchair is manually driven by two rear wheels which are typically 700c sizing with hand rim diameters between 12″ and 17″. The front wheel of the wheelchair typically has a 20″ diameter and is attached to the wheelchair frame with a fork and steered with a single steering arm that is connected to the fork through a bearing housing. The brake lever for the steering is integrated into the handlebar of the steering arm to save weight and improve aerodynamics. The bearing housing for the steering uses a sealed angular contact bearing at the base of a shaft or stem that has a large diameter to improve steering stability, with a regular crown race bearing in the top of the wheelchair frame.

The seating cage is made to measure and can be specialized to ergonomic and performance dimensions of a user. The carbon main frame and axle can be cut to a variety of lengths to suit the user requirements.

The wheelchair also includes a compensator assembly, in particular with an adjusting arm, which may comprise a rocking bar attached to the fork, that allows the user to preset a turning circle for the wheelchair to match the radius of a track. This allows the user to hit an adjusting arm quickly in between driving the rear wheels to turn with the track. The user can then continue with both hands to drive the wheelchair so limited speed is lost by steering the bend. The arm can then be hit again in the opposite direction to return the steering to center.

It should be understood that any one of the described features and/or embodiments of the disclosure may be used separately or in combination with other disclosed features and/or embodiments.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of the front part of a known, prior art racing wheelchair.

FIG. 2 is an exploded view of the front part of a racing wheelchair according to the invention.

FIG. 3A is a perspective view of the racing wheelchair of the present disclosure.

FIG. 3B is a perspective view of a part of a frame of the racing wheelchair of FIG. 3a, with an integrated steering arm having a brake assembly.

FIGS. 4A-4J are different views of the steering arm shown in FIG. 3B.

FIGS. 5A-5C are different views of the brake assembly shown in FIG. 3B.

FIG. 5D is an exploded view of the brake assembly shown in FIG. 5C.

FIG. 6 is a cross-sectional view of the brake assembly shown in FIGS. 5A to 5C.

### DETAILED DESCRIPTION OF THE PREFERRED EMBODIMENT

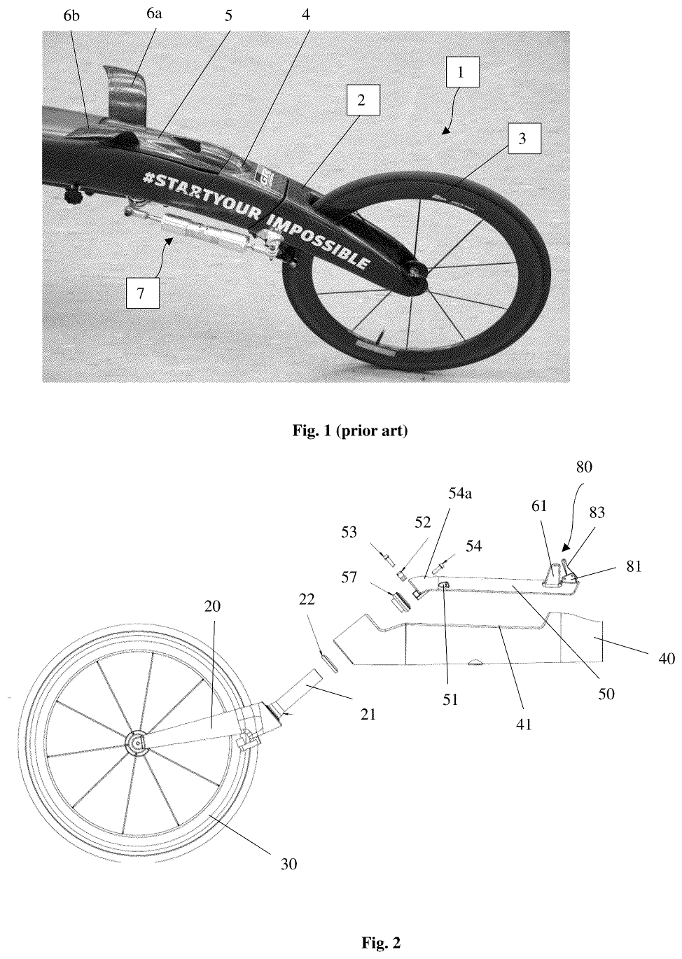

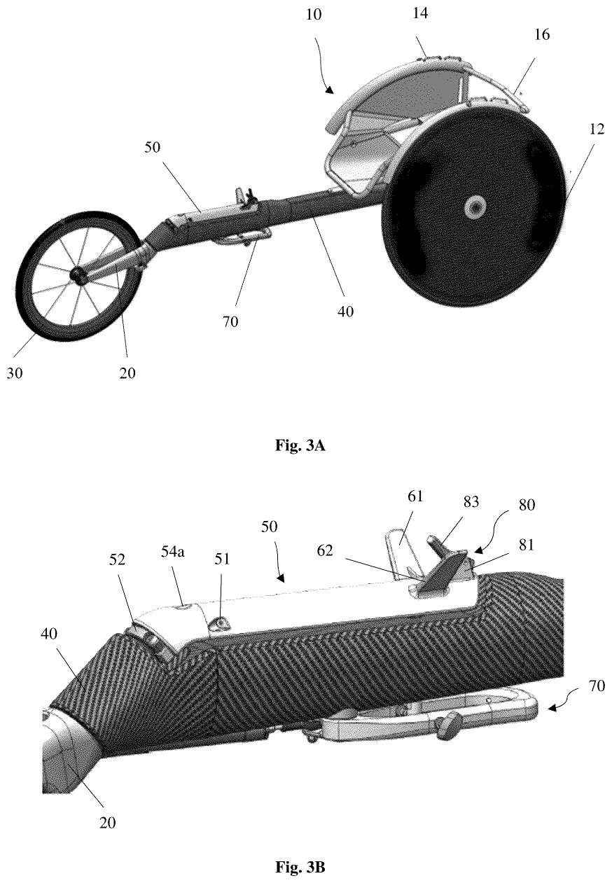

FIG. 2 shows, in analogy to FIG. 1, the front of a racing wheelchair 10, but according to the present disclosure and in an exploded view. Said racing wheelchair 10 has a fork 20 for mounting a front wheel 30; and the fork 30 is connected with a wheelchair frame 40. For the purpose of this connection, the fork 20 is provided with a machined stem 21 having a larger diameter at its base to house a sealed angular contact bearing 22 and to increase stability when turning. The stem 21 extends through the wheelchair frame 40 and passes a crown race bearing 67 to enter a steering arm 50 to be inserted into the wheelchair frame 40, with a top clamp 52 to fix the unit via a mounting pin 53. A bolt 54, which preferably is a lightweight titanium bolt 54, is to be inserted into an opening 54a in the steering arm 50 to complete the fixing.

The wheelchair frame 40 is provided as a carbon unit with a recess 41 for accommodating the steering arm 50 such that the top surface of the steering arm 50 flushes into the wheelchair frame 40.

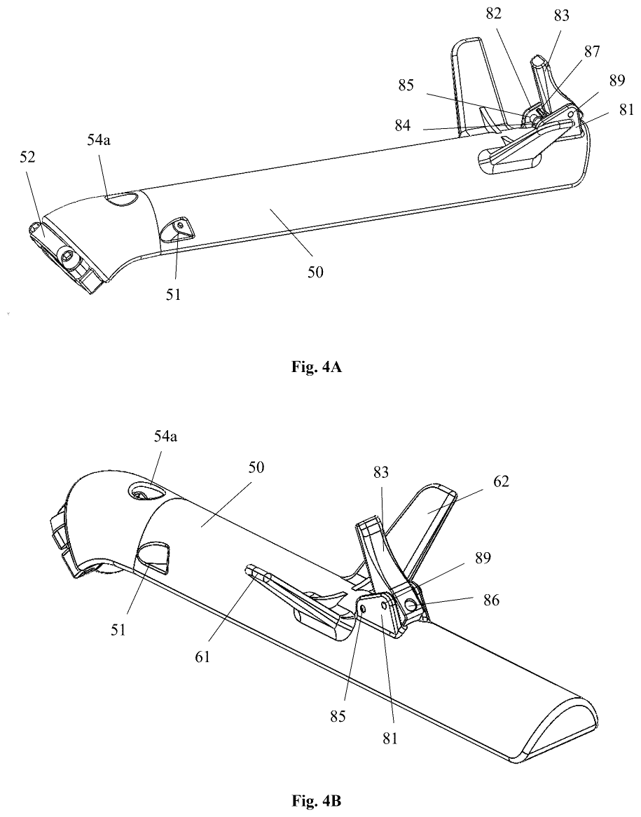

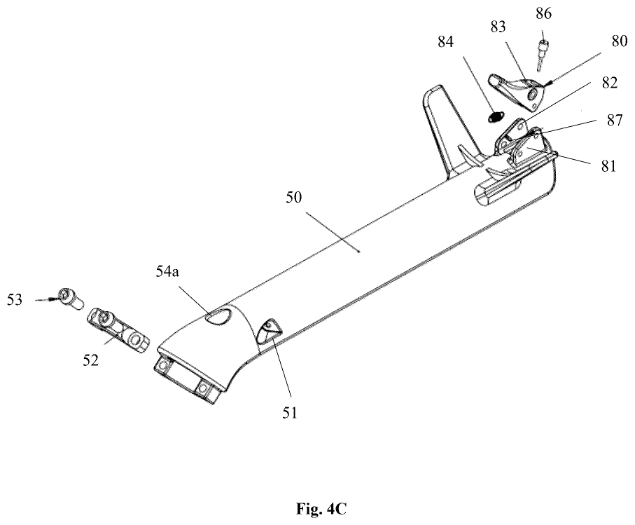

The steering arm 50 is provided with two steering means 61, 62 and a brake assembly 80. Said brake assembly 80 is comprising two mounting plate 81, 82 and a brake lever 83. Before concentrating on the further parts establishing the brake assembly 80, it is turned to FIG. 3A showing the racing wheelchair 10 with its further components, in particular its two drive wheels 12, 14 and a steering cage 16 for a user at the rear, and to FIG. 3B showing the part of the wheelchair frame 40 of the racing wheelchair 10 into which the steering arm 50 is inserted and a compensator assembly 70. FIG. 3B also shows, a brake cable through hole 51.

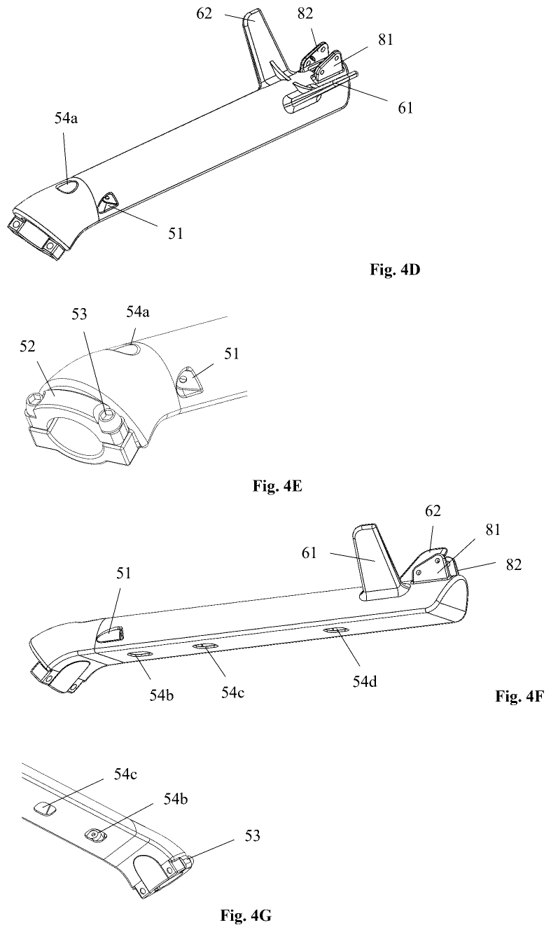

FIG. 4A to 4J show the steering arm 50 with all of its components from different views.

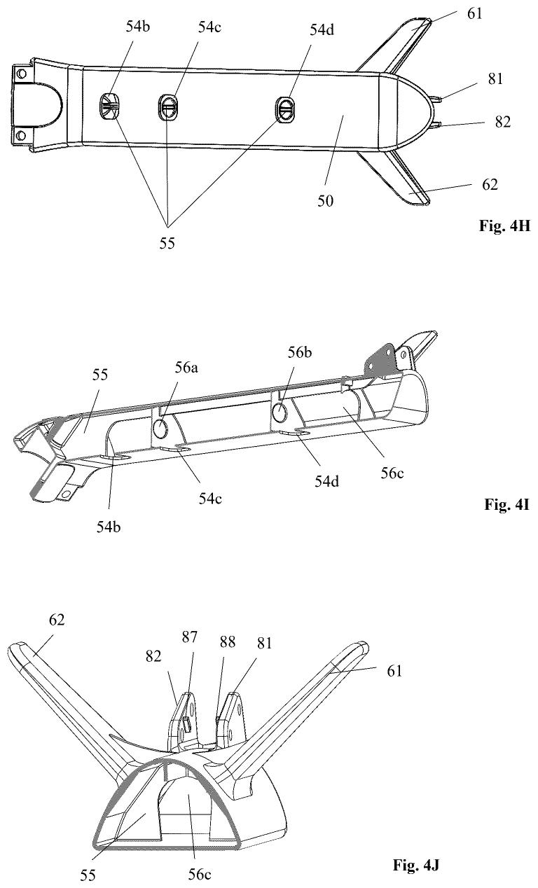

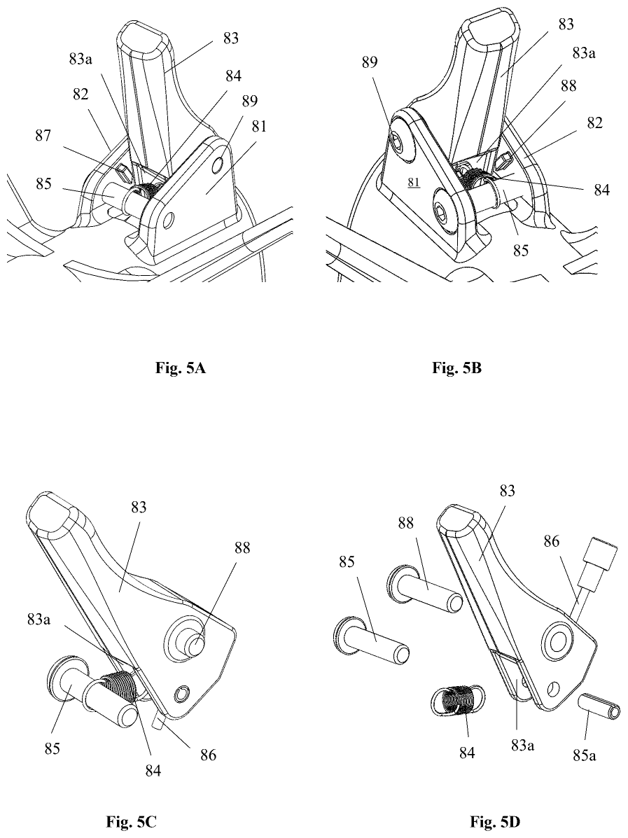

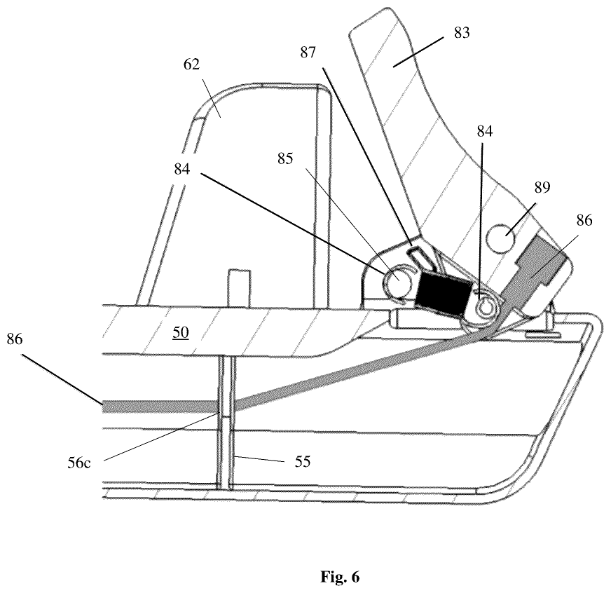

While FIG. 4A provides a similar view of the steering arm 50 as FIG. 3B, i.e. a side perspective view, FIG. 4B provides a rear perspective view also showing one end of a brake cable 86 entering into the bake lever 83. Further a spring mount pin 85 and a lever pivot 89 can be seen in FIGS. 4A and 4B, while the exploded view of FIG. 4C provides details of the installation of the brake lever 83. Accordingly, the brake lever 83 is pivotally installed between the two mounting plates 81, 82 via the lever pivot 89, and a spring 84 is attached to the spring mount pin 85 and engages the brake lever 83 as well as a brake cable 86, as best seen in FIG. 6, in order to bias the brake lever 83 in a non-braking position. The braking assembly 80 will be further described below with respect to FIGS. 5A to 5C and 6.

FIG. 4D shows the single piece steering arm 50 which is made by using 3D printed aluminum. This allows said single piece to be designed into an aerodynamic form for optimal performance while also allowing for the brake assembly 80 to be integrated into the steering arm 50 in order to act as a handlebar. The brake lever 83 in contrast is formed as a 3D printed glass filled nylon unit for reducing weight and providing sufficient strength to the braking assembly 80.

FIG. 4E is a perspective front view of the single piece steering arm 50 with the clamp 52 being mounted and fixed via the mounting pin 53. FIGS. 4F to 4H all show details of the bottom of the single piece steering arm 50 with three further openings 54b, 54c and 54d allowing to look into the steering arm 50 and showing its inner frame 55, while the longitudinal section of FIG. 4I and the cross-section of FIG. 4J provide details of said frame 55. Accordingly the frame 55 comprises a ribbing for enforcement, which in turn is provided with brake cable openings 56a, 56b and 56c allowing the brake cable 86, which is not shown in said figures, to be guided through the single piece steering arm 50, including its frame 55, from the brake lever 53 until the hole 51 at the end facing the fork 20. Threading the brake cable 86 through the steering arm 50 may be surveyed through the openings 54b, 54c and 54d.

FIG. 4I shows the triangular shape of the cross-section of the steering arm 50 with rounded edges.

FIG. 5A to 5D show the brake assembly 80 with all of its components from different views; and the longitudinal cross-section of FIG. 6 of the rear end of the steering arm 50 provides further details on the integration of the brake assembly 80 into the steering arm 50.

The two perspective views of FIGS. 5A and 5B, taken from the one and the other side, not only show the brake lever 83 between the two mounting plates 81, 82, but also two stop elements 87, 88, one provided on each of the two mounting plates 81, 82. The two stop elements 87, 88 ensure that that the brake lever 83 has a mechanical stop preventing the brake lever 83 of being pressed into one of the wings 61, 62 or pass a return spring limit of the spring 84. The spring 84 extends from the spring mount pin 85 in front of the stop elements 87, 88 to the brake cable 86 by passing below a part of the brake lever 83, even entering into the brake lever 83 through an opening 83a, see FIG. 6.

As described above, although the embodiments are described by the limited embodiments and the drawings, various modifications and changes may be made by those skilled in the art from the above description. For example, appropriate results may be achieved even if the described techniques are performed in a different order than the described method, and/or components of the described system, structure, apparatus, circuit, etc. are combined or combined in a different form than the described method, or replaced or substituted by other components or equivalents.

Therefore, other implementations, other embodiments of the present disclosure, and those equivalent to the claims also fall within the claims to be described below.

### REFERENCE SIGNS

1 racing wheelchair
2 fork
3 front wheel
4 frame
5 steering arm
6a, 6b steering means
7 compensator assembly
10 racing wheelchair
12 drive wheel
14 drive wheel
16 steering cage
20 fork
21 stem
22 sealed angular contact bearing
30 front wheel
40 wheelchair frame
41 recess
50 steering arm
51 brake cable through hole
52 clamp
53 mounting pin
54 bolt
54a-54d opening
55 frame
56a-56c brake through or opening for brake cable
57 bearing
61,62 steering means
70 compensator assembly with adjusting arm
80 brake assembly
81,82 mounting plate
83 brake lever
83a brake lever opening
84 spring
85 spring mount pin
85a fasting element
86 brake cable
87,88 stop element
89 lever pivot

The principle and mode of operation of this invention have been explained and illustrated in its preferred embodiment. However, it must be understood that this invention may be practiced otherwise than as specifically explained and illustrated without departing from its spirit or scope.

What is claimed is:

1. A brake assembly for a personal mobility vehicle, configured as a racing wheelchair, comprising a brake lever for actuating a brake cable, wherein the brake lever is one of a three dimensional (3D) printed glass filled nylon unit or a 3D printed unit containing up to 30% glass filled nylon.

2. The brake assembly of claim 1, wherein the brake lever is adapted to be mounted to a steering arm comprising a three dimensional (3D) printed aluminium, in particular Aluminium grade ALSI10 mg and/or with a triangular cross-section with smoothed edges.

3. The brake assembly of claim 2, wherein the brake lever is adapted to be pivotally mounted between the two mounting plates provided by the steering arm via a lever pivot extending from one mounting plate to the other mounting plate and passing through the brake lever.

4. The brake assembly of claim 1, wherein a spring device, in particular comprising a spring, preferably in form of a coil spring, which is attached at a spring mount pin and engages the brake lever and/or the brake cable.

5. The brake assembly of claim 4, wherein the spring mount pin is adapted to be mounted between the two mounting plates, extending from one mounting plate to the other mounting plate in front of the brake lever, wherein the spring extends into the brake lever via a brake lever opening.

6. The brake assembly of claim 5, wherein at least one stop element limits the movement of the brake lever, wherein each mounting plate provides one stop element between the spring mount pin and the brake lever.

7. The brake assembly of claim 1, wherein the brake cable extends from the brake lever longitudinally through a steering arm.

8. A steering arm assembly comprising a steering arm with the brake assembly of claim 1 being integrated into the steering arm.

9. The steering arm assembly of claim 8, wherein the steering arm is formed with the mounting plates and steering means, preferably in a form of wings and/or in a travelling direction of the personal mobility vehicle in front of the mounting plates.

10. The steering arm assembly of claim 9, wherein each wing has a smaller surface area in the travelling direction compared to the side area and adapted for being gripped from the side by a user of the personal mobility vehicle.

11. The steering arm assembly of claim 8, wherein a frame formed with the steering arm for reinforcement, in particular providing a ribbing and/or extending longitudinally and across the interior of the steering arm.

12. The steering arm assembly of claim 11, wherein the frame, in particular in the region of the ribbing, provides one or more brake openings for the brake cable.

13. The steering arm assembly of claim 8, wherein a brake cable through hole at the front end of the steering arm in the travelling direction allows the brake cable to exit from the interior of the steering arm.

14. The steering arm assembly of claim 8, wherein at least one further opening of the steering arm, in particular at the side opposite the mounting plates, for surveying the threading of the brake cable through the steering arm.

15. The steering arm assembly of claim 8, wherein the steering arm is adapted to be integrated into a personal mobility vehicle frame, in particular with at least one first fastening element, and attached to a fork for a front wheel of the personal mobility vehicle, in particular with at least one second fastening element.

16. The steering arm assembly of claim 15, wherein the first fastening element comprises a bolt, in particular a lightweight titanium bolt, extending through another opening of the steering arm at the side of the mounting plates and at the front end in the travelling direction of the personal mobility vehicle, and/or the second fastening element comprises a clamp adapted to be fastened to a stem of the fork, in particular via a mounting pin.

17. The steering arm assembly of claim 15, wherein the personal mobility vehicle frame is provided as a carbon frame and/or with at least a region having a non-circular cross-section and/or with at least one wall sections thickened.

18. A racing wheelchair with a front wheel attached to a wheelchair frame via a fork, and with two drive wheels as well as a steering cage mounted on the rear of the wheelchair frame, and further including the brake assembly of claim 1 and/or the steering arm assembly of claim 8.

19. The racing wheelchair of claim 18, wherein the wheelchair frame has a recess for accommodating the steering arm such that the top surface of the steering arm is generally flush with the wheelchair frame, and/or the wheelchair frame tapers at its front and is generally flush with the fork, and/or the interface between the wheelchair frame and the fork is a cylindrical region.

20. The racing wheelchair of claim 18, wherein a stem of the fork is machined and/or
has a larger diameter at its base to house a bearing, in particular a sealed angular contact bearing, between the fork and the wheelchair frame, and/or
extends through the wheelchair frame and passes a further bearing, in particular a crown race bearing, to enter the steering arm.

21. The racing wheelchair of claim 18, wherein a compensator assembly comprises a rocking bar attached to the fork and the wheelchair frame and configured to allow a wheelchair user to preset a turning circle for the wheelchair.
